(19) United States
(12) Patent Application Publication
(10) Pub. No.: US 2026/0235421 A1
(43) Pub. Date: Aug. 13, 2026

(54) DEVICE FOR MEASURING A PHYSICAL QUANTITY

(71) Applicant: COMMISSARIAT A L'ENERGIE ATOMIQUE ET AUX ENERGIES ALTERNATIVES, Paris (FR)

(72) Inventors: Romain COTILLARD, Grenoble Cedex 09 (FR); Guillaume LAFFONT, Grenoble Cedex 09 (FR); Nicolas ROUSSEL, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/136,687

(22) PCT Filed: Dec. 6, 2023
(86) PCT No.: PCT/EP2023/084521

§ 371 Date: Jun. 6, 2025

(30) Foreign Application Priority Data
Dec. 9, 2022 (FR) FR2213084

(51) Int. Cl. G01D 5/353; G01K 11/3206; G01L 1/24; G01L 11/02; G02B 5/28

(52) U.S. Cl. CPC G01D 5/35316; G01K 11/3206; G01L 1/246; G01L 11/025; G02B 5/284

(57) ABSTRACT

A measurement device including an etalon, the reflection power spectrum of which includes multiple power peaks distributed within a working range, the free spectral range of the etalon being less than or equal to 5 nm. The etalon including a waveguide, and a Bragg grating formed in the waveguide, the Bragg grating including at least three identical patterns aligned one behind the other along a longitudinal axis of the waveguide and separated from one another by a constant spacing. The spacing of the Bragg grating is configured for the power spectrum of the grating to have multiple discernible harmonics with an order greater than one hundred in the working range, these harmonics thus forming the power peaks of the power spectrum of the etalon.

The invention concerns a device for measuring a physical quantity as well as a standard (etalon) for the realization of this device.

These devices are used, for example, to measure temperature, pressure or mechanical deformation.

An example of such a known measuring device is described in application CN102879022A. This known device comprises a standard and an optical transducer. The optical transducer transforms a variation in the physical quantity to be measured into a shift of a power peak in the power spectrum of the optical transducer. The standard is used to generate a reference power spectrum, which is used to correct the measurement and thus improve its accuracy.

To achieve this, the standard's power spectrum comprises a succession of closely spaced power peaks within a predetermined working range.

To date, many different ways of realizing such a standard have been proposed. For example, it has been proposed to realize such an standard using a Fabry-Pérot cavity whose optical interfaces are mirrors connected to the ends of an optical fiber. Such mirrors have a high reflectivity, i.e. over 90%. Under these conditions, the peaks of the power spectrum of the standard are fine and the precision of the measuring device is high. However, the manufacture of such a Fabry Perot cavity is complex, in particular because mirrors have to be connected to the ends of an optical fiber. An example of such an standard is described in application WO2020113147A1.

In application CN102879022A, it is proposed to realize the standard by engraving in the core of an optical fiber a succession of Bragg gratings located one after the other. The wavelength AB of the fundamental resonant frequency fs of each of these Bragg gratings is different from that of the other Bragg gratings. However, the power peak widths of the standard of application CN102879022A are generally less fine than those obtained using a standard such as that of application WO2020113147A1. Moreover, such a succession of Bragg gratings is complex to produce and often leads to a rather long and therefore bulky standard.

Prior art is also known from US2019/178688A1 and US2020/271485A1.

The aim of the invention is to provide a device for measuring a physical quantity which is highly accurate and, at the same time, simple to manufacture.

The invention is set out in the attached set of claims.

The invention will be better understood on reading the following description, given solely by way of non-limiting example and made with reference to the drawings on which:

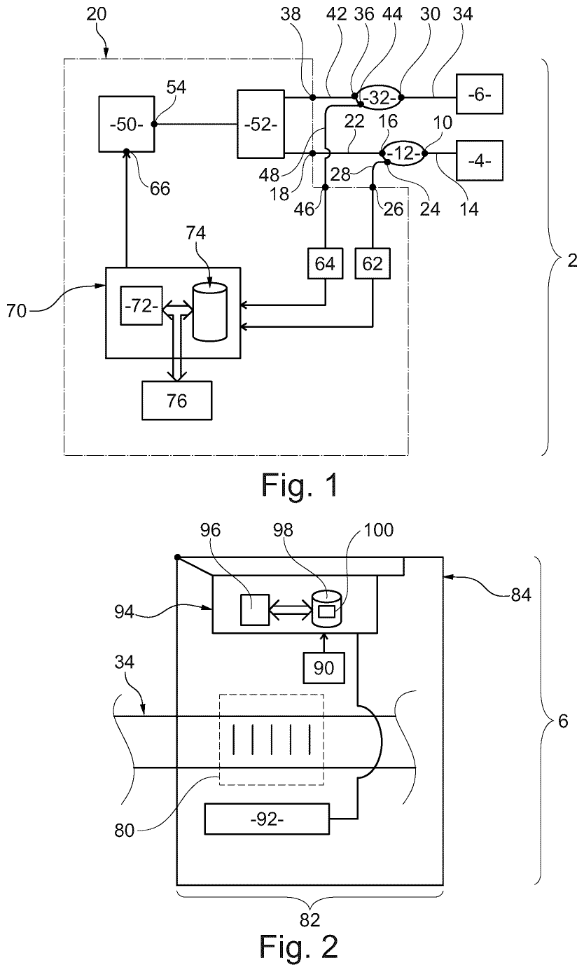

FIG. 1 is a schematic illustration of the architecture of a device for measuring a physical quantity,

FIG. 2 is a schematic illustration of a standard of the measuring device shown in FIG. 1,

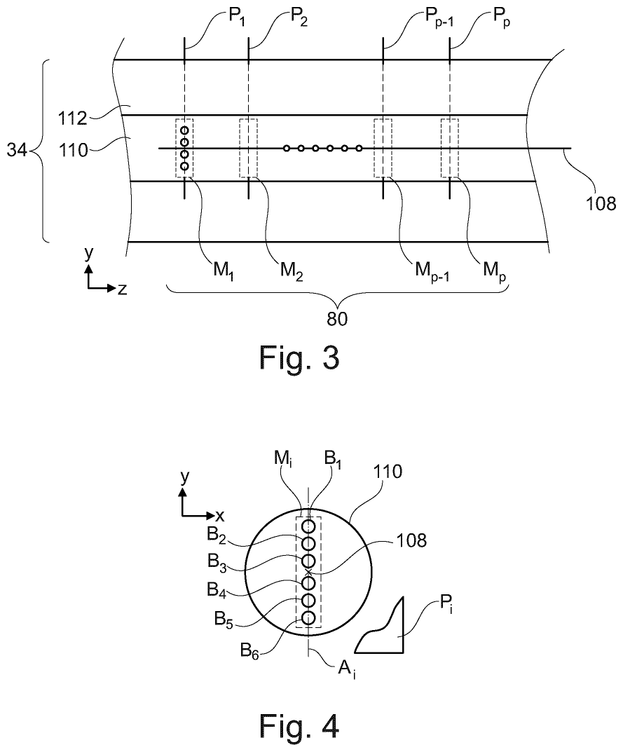

FIG. 3 is a partial schematic illustration, in longitudinal section, of a Bragg grating used in the standard shown in FIG. 2,

FIG. 4 is a schematic cross-sectional illustration of the Bragg grating pattern shown in FIG. 3,

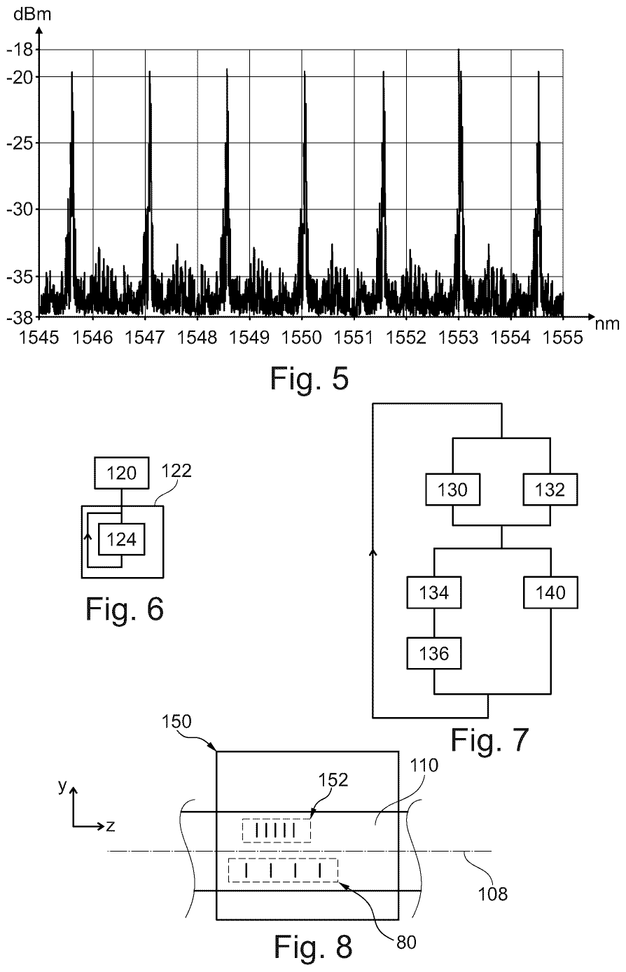

FIG. 5 is a graph representing a portion of the power spectrum of the Bragg grating of FIG. 3,

FIG. 6 is a flowchart of a manufacturing method for the Bragg grating shown in FIG. 3,

FIG. 7 is a flowchart of a method for measuring a physical quantity using the device shown in FIG. 1, and

FIG. 8 is a partial schematic illustration, in longitudinal section, of another type of standard for the measuring device shown in FIG. 1.

In these figures, the same references are used to designate the same elements. In the remainder of this description, features and functions well known to the skilled person are not described in detail.

In this description, detailed examples of embodiments are first described in chapter I with reference to the figures. Then, in chapter Il, variants of these embodiments are introduced. Finally, the advantages of the various embodiments are described in chapter III.

### Chapter I: Examples of Embodiments

FIG. 1 shows a device 2 for measuring a physical quantity. Here, for example, the physical quantity to be measured is the temperature of an external environment.

Device 2 comprises an optical transducer 4 and a standard 6. Transducer 4 is exposed to variations in the physical quantity to be measured.

Transducer 4 transforms a variation in the physical quantity to be measured into a shift of a power peak of its power spectrum. In this text, unless otherwise specified, the term “power spectrum” or “spectrum” refers to the reflection power spectrum. The reflection power spectrum is the power spectrum of the optical signal reflected by an optical component. A peak in the reflection power spectrum corresponds to an absorption line in the transmission power spectrum of the same optical component.

The power spectrum of transducer 4 comprises, for example, a single power peak in a predetermined working range. This working range is wider than 5 nm. Typically, its width is also less than or equal to 200 nm or 120 nm. Here, the width of the working range is equal to 100 nm. The working range lies within the optics domain. The optics domain refers to the range containing the wavelengths typically used in optics. More precisely, in this text, the optics domain refers to the range extending from 200 nm to 10000 nm and, frequently, from 200 nm to 5000 nm or from 400 nm to 2000 nm.

For example, transducer 4 is identical or similar to that described in application CN102879022A. Transducer 4 is thus here a Bragg grating which is realized in the core of an optical fiber 14. The wavelength λ_{B4} of the fundamental frequency f_{B4} of this Bragg grating lies within the predetermined working range. Preferably, the wavelength λ_{B4} is located substantially in the middle of the working range. The wavelength of the fundamental frequency of a Bragg grating is given by the following relationship (1): λ_{B}=2*nₑ*Λ, where:
λ_{B} is the wavelength of the fundamental frequency of the Bragg grating,
nₑ is the effective index of the optical fiber inside which the Bragg grating is formed,
Λ is the Bragg grating spacing, and
the symbol “*” refers to the scalar multiplication operation in this text.

The effective propagation index nₑ is also known as the “mode phase constant”. It is defined by the following relationship: n_{g}=nₑ−λdnₑ/dλ, where n_{g} is the group index and λ is the wavelength of the optical signal guided by the optical fiber. The effective propagation index of an optical fiber depends on the dimensions of the core of this optical fiber and the materials forming this core and the optical cladding of this optical fiber. It can be determined experimentally or by numerical simulation.

Standard 6 has a reflection power spectrum with several power peaks distributed within the working range. The free spectral range of this standard over the working range is less than or equal to 5 nm, and preferably less than or equal to 1 nm. Hereinafter, such a succession of peaks is also referred to as “a comb of peaks” or simply “a comb”. Unlike the transducer 4, the standard 6 is configured so that its power spectrum is constant. In particular, standard 6 is arranged so that its power spectrum does not shift as a function of the physical quantity measured or as a function of variations in other physical quantities of the external environment in which standard 6 is immersed. In particular, standard 6 is arranged so that its power spectrum does not shift as a function of the temperature of the external environment. In this text, “does not shift” means that the amplitude of the shift of the power spectrum of the standard 6 is negligible in front of the amplitude Δλ of the shift of the power spectrum of the transducer 4 observed at the same time. Here, the amplitude of the shift of the power spectrum of the standard 6 is considered negligible if it is ten or one hundred times less than the amplitude Δλ.

Transducer 4 is optically connected to an input/output port 10 of an optical coupler 12 via a waveguide 14. The optical coupler 12 comprises:
an input port 16 optically connected to an output port 18 of a spectral analyzer 20 via a waveguide 22, and
an output port 24 optically connected to an input port 26 of the spectral analyzer 20 via a waveguide 28.

The standard 6 is optically connected to an input/output port 30 of an optical coupler 32 via a waveguide 34. The optical coupler 32 comprises:
an input port 36 optically connected to an output port 38 of the spectral analyzer 20 via a waveguide 42, and
an output port 44 optically connected to an input port 46 of the spectral analyzer 20 via a waveguide 48.

In this embodiment, all the above waveguides are respective optical fibers. Thus, hereafter, the same numerical references are used to designate the waveguide or the optical fiber. Here, the optical fibers used are single-mode optical fibers also known by the acronym SMF (“Simple Mode Fiber”).

The spectral analyzer 20 is capable of measuring the spectral responses of the transducer 4 and the standard 6, then determining the variation in the physical quantity to be measured from these measured spectral responses. To do this, it comprises:
a tunable laser source 50,
an optical coupler 52, which optically connects an output port 54 of laser source 50 to both output ports 18 and 38 simultaneously,
two optical sensors 62 and 64 optically connected, respectively, to input ports 26 and 46 to measure the power of the optical signal received at these input ports, and
an electronic processing unit 70 electrically connected to the sensors 62, 64 to receive electrical signals representative of the powers of the optical signals measured by, respectively, the sensors 62 and 64.

Laser source 50 emits a single-frequency optical signal via port 54 to transducer 4 and standard 6. The wavelength λₛ of the emitted optical signal is in the optics domain. The value of the wavelength λₛ depends on a control signal received at a control port 66 of the laser source 50. More precisely, the wavelength λₛ is linked to the value of the control signal by a transfer function which, to each value of the control signal, associates a corresponding value of the wavelength λₛ. Typically, this transfer function is not perfectly linear. In this case, it is said to be “non-linear”. Such a laser source 50 is also called a “scanning laser source”. This is because, using an appropriate control signal, the wavelength λₛ scans the entire working range. Here, the working range is a wavelength range that extends from wavelength λₛₘᵢₙ to wavelength λₛₘₐₓ. The width of the working range is typically determined by the characteristics of the source 50. The working range width is equal to the difference λₛₘₐₓ−λₛₘᵢₙ. In this embodiment, this working range extends from 1500 nm to 1600 nm.

Sensor 62 measures the optical signal backscattered by transducer 4. In parallel, sensor 64 measures the optical signal backscattered by standard 6. Here, sensors 62 and 64 are identical. For example, sensors 62 and 64 are each a photodiode. Each of the sensors 62, 64 has a spectral range of observation that encompasses the working range.

In particular, unit 70 is configured to:
determine the amplitude Δλ of the peak shift of transducer 4 from the spectral responses of transducer 4 and standard 6 measured separately from each other by sensors 62 and 64 respectively, then
establish a variation in the physical quantity to be measured from the amplitude AA determined.

To carry out these operations, unit 70 comprises a programmable microprocessor 72 and a memory 74 containing the data and instructions required to operate spectral analyzer 20. For example, here, the memory includes a sensitivity coefficient So that establishes the variation of the physical quantity from the determined amplitude Δλ. In this example, the coefficient S_{G} is defined by the following relationship Δλ/λ_{Bi4}=S_{G}*ΔG, where:
λ_{Bi4} is the wavelength of the fundamental frequency of the Bragg grating of transducer 4 in a reference state, and
Δλ is the amplitude of the variation in the wavelength of the fundamental frequency of the Bragg grating of transducer 4 obtained in response to a variation ΔG in the physical quantity to be measured.

The wavelength λ_{Bi4} corresponds, here, to a reference wavelength for the power peak of transducer 4. The amplitude Δλ is equal to the difference between the wavelength λ_{Bm4} of the fundamental frequency measured for transducer 4 and the reference wavelength λ_{Bi4}. Unlike the wavelength λ_{Bi4}, the wavelength λ_{Bm4} varies as a function of the physical quantity to be measured. The value of the wavelength λ_{Bi4} is stored in memory 74. This wavelength λ_{Bi4} can also be associated, in memory 74, with a corresponding absolute value of the physical quantity to be measured.

Usually, the unit 70 is also connected to a man-machine interface 76 to communicate the result of the measurements made to a human being.

FIG. 2 shows the architecture of standard 6 in greater detail. The standard 6 comprises a Bragg grating 80 manufactured into the core of the optical fiber 34. The grating 80 is a very high-order Bragg grating.

In this text, “very high order” refers to the fact that the power spectrum of the Bragg grating exhibits discernible harmonics of order greater than N in the optics domain and, more precisely, in the working range, where N is an integer greater than 100 and, preferably, greater than 500 or 1000. In other words, in the reflection power spectrum of a very high-order Bragg grating, there are harmonics of order k, greater than N, which each correspond to a power peak distinct from the peaks corresponding to harmonics of order k−1 and k+1. This k-order peak is also higher than the noise. This k-order peak is located at the wavelength λₖ defined by the following relationship (2): λₖ=2*nₑ*Λ/k, where:
k is an integer equal to the order of the harmonic,
nₑ is the effective index of the optical fiber in which the very high-order Bragg grating is realized,
Λ is the spacing of the very high-order Bragg grating.

Here, this k-order peak is located within the working range.

The power spectrum of grating 80, within the working range, comprises a succession of peaks each corresponding to a harmonic of order greater than N. These peaks are very close together and very fine. In this text, “very close” means that the free spectral range is less than 5 nm and, preferably, less than or equal to 1 nm. “Very fine” means that the half-height width of each peak is less than the free spectral range and, preferably, less than half of the free spectral range. Furthermore, the heights of these peaks are substantially the same over the entire working range, as each of these peaks corresponds to a very high-order harmonic. In other words, the power spectrum of the grating 80 is a comb of peaks as previously defined. An example of such a comb is shown in FIG. 3 of the following article: Pengtao Luo et Al: “Femtosecond laser plane-by-plane inscribed ultrahigh-order fiber Bragg grating and its application in multi-wavelength fiber lasers”, Optic letter, 15 Jun. 2022. This article is hereafter referred to as “LUO2022”.

A very high-order Bragg grating differs from the standard Bragg gratings commonly used in optics in a number of ways. In standard Bragg gratings, the spacing of the standard Bragg grating is chosen:
so that the wavelength λ_{B} of the fundamental resonant frequency f_{B} of the Bragg grating is in the optics domain, or
that only first harmonics of order less than twenty are in the optics domain.

As a result, the spacing of these standard Bragg gratings is systematically less than 50 μm or 20 μm, and usually even less than 10 μm. Under these conditions, the standard Bragg grating cannot be a very high-order Bragg grating. Indeed, in this case, even if harmonics of order k greater than one hundred are discernible in its power spectrum, the wavelength λₖ of these harmonics is not in the optics domain. In other words, the wavelengths Δₖ of harmonics of order k greater than one hundred, are all less than 200 nm. Conversely, the spacing of a Bragg grating of very high order is greater than 20 μm or 50 μm, and often greater than 100 μm. Under these conditions, the wavelength λ_{B} of the fundamental resonant frequency f_{B} of the very high-order Bragg grating, and the wavelengths of its harmonics of order less than one hundred, are not in the optics domain.

Standard Bragg grating patterns are commonly fabricated using ultraviolet radiation pulses or CO₂ lasers, rather than femtosecond laser pulses. Bragg gratings fabricated without the use of femtosecond laser pulses exhibit only discernible harmonics of order less than twenty. This seems to be due to the fact that the refractive index variations in the optical fiber obtained using these other known methods are much less sharp than those obtained using a femtosecond laser. Thus, a Bragg grating produced without using femtosecond laser pulses, even if it has a spacing greater than 20 μm or 50 μm, is not a very high-order Bragg grating.

It should also be emphasized that a Bragg grating should not be confused with a juxtaposition of Fabry-Perrot cavities along an optical fiber. Indeed, the spectral characteristics of an optical fiber comprising such a juxtaposition of Fabry-Perrot cavities depend on the lengths of each Fabry-Perrot cavity and on the reflectivity of the optical interfaces located at each end of each Fabry-Perrot cavity. Unlike a Bragg grating, the optical interfaces are not spaced apart by a constant spacing to form a periodic structure.

Bragg gratings are also frequently used, in the field of laser sources, to form the end optical interfaces of a Fabry Perot cavity of this laser source. In this case, the spectral response of this cavity is mainly determined by the length of the cavity and not by the spectral characteristics of the Bragg gratings used. More precisely, as taught in LUO2022, the spectral characteristic of the Bragg gratings is then used to adjust the wavelength(s) of the laser source. This use of very high-order Bragg gratings in laser sources lies outside the scope of the field of measuring a physical quantity. In particular, this usage does not teach that a high-order Bragg grating can advantageously be used to produce a standard for a measuring device.

Standard 6 is also designed to ensure that the power spectrum of grating 80 remains constant, despite variations in operating conditions. To this end, it includes an insulating structure 82 which isolates the grating 80 from variations in the external environment in which the standard 6 is immersed. In this embodiment, the insulating structure 82 comprises a housing 84 inside which the grating 80 is fixed without any degree of freedom. Housing 84 isolates grating 80 from the variations in mechanical stress that the external environment can exert on grating 80.

The insulating structure 82 also includes in the housing 84:
a temperature sensor 90,
a tunable heating or cooling element 92 capable of heating or cooling the grating 80, and
a microcontroller 94 configured to control the heating element as a function of a temperature setpoint Tc and the temperature measured by sensor 90 to limit temperature variations in grating 80 around this setpoint Tc.

Element 92 is, for example, a Peltier module or a set of several Peltier modules.

The microcontroller 94 comprises a programmable microprocessor 96 and a memory 98 containing the data and instructions required to operate the standard 6. In this case, memory 98 contains the pre-stored setpoint Tc and the instructions for a servo-control module 100. When module 100 is executed by microprocessor 96, the temperature of grating 80 is controlled by the setpoint Tc stored in memory 98. To do this, microprocessor 96 controls element 92 as a function of a deviation between setpoint Tc and the temperature measured by sensor 90, so as to reduce this deviation.

FIG. 3 shows a more detailed example of the grating 80. The optical fiber 34 extends along a longitudinal axis 108 parallel to a Z direction of an orthogonal reference frame XYZ. FIGS. 3, 4 and 8 are oriented with respect to this XYZ reference frame. For example, the Z direction is horizontal and the Y direction is vertical.

To simplify FIG. 3, only the portion of optical fiber 34 containing grating 80 is shown. Optical fiber 34 guides the optical signal along longitudinal axis 108.

Optical fiber 34 comprises:
a core 110 in which the optical signal guided by this fiber 34 propagates,
an optical cladding 112 made of a material whose refractive index keeps the optical signal inside the core 110 by reflection at the interface between the core 110 and this cladding 112, and
a mechanical sheath, typically made of polymer, covering the cladding 112. To simplify FIG. 3, the mechanical sheath of optical fiber 34 has not been shown.

Grating 80 is designed to produce a comb of peaks over the working range. Moreover, here, grating 80 is designed so that this comb is formed by harmonics of grating 80 of order close to 1024.

To this end, grating 80 is composed of a succession of patterns Mᵢ arranged one behind the other along axis 108. The index i is the sequence number of the pattern in the Z direction. The index i of the first left-most pattern in the grating 80 is equal to 1 and the index i of the last right-most pattern in the grating 80 is equal to p. p is equal to the number of patterns Mᵢ in the grating 80. In FIG. 3, only the first two and last two patterns in the grating 80 are shown. The presence of intermediate patterns between M₂ and Mₚ₋₁ is represented by small circles on axis 108.

The number p of patterns is greater than or equal to three, and preferably greater than or equal to ten. Indeed, it has been observed that the greater the number p, the smaller the width at half-height of each peak. Here, the number p is also chosen to be small enough to keep the length of grating 80 small, i.e. less than 1 meter and preferably less than 10 cm. The length of grating 80 is equal to the distance between patterns M₁ and Mₚ measured along axis 108. Typically, the number p is less than 200 or 100.

The spacing κ₈₀ between two immediately consecutive patterns Mᵢ and Mᵢ₊1 in the Z direction is constant whatever the index i. The spacing Λ₈₀ is therefore equal to the distance, along axis 108, between two immediately consecutive patterns Mᵢ and Mᵢ₊₁.

Here, the spacing size Λ₈₀ is calculated so that the wavelength of a harmonic of order k_{c} is equal to or very close to the center of the working range. Here, the order k_{c} is chosen to be equal to 1024.

For this purpose, the spacing κ₈₀ is between 0.9*[k_{c}*λ_{c}/(2*nₑ)] and 1.1*[k_{c}*λ_{c}/(2*nₑ)] and, preferably, between 0.98*[k_{c}*λ_{c}/(2*nₑ)] and 1.02*[k_{c}*λ_{c}/(2*nₑ)], where nₑ is the effective index of the optical fiber 34 and λ_{c} is the wavelength at the center of the working range. Here, the wavelength λ_{c} is equal to 1550 nm.

By way of example, optical fiber 34 is made from an optical fiber marketed under the reference SMF-28 by the Corning® company. The index nₑ of this optical fiber is equal to approximately 1.4676. Under these conditions, the term k_{c}+λ_{c}/(2*nₑ) is equal to approximately 540.8 μm. Here, the spacing Aso is chosen equal to 540.8 μm. With this choice of this value for the spacing Λ₈₀, only harmonics of order between 317 and 7936 are in the optics domain and only harmonics of order between 993 and 1058 are within the working range. In particular, the wavelength λ_{B80} of the fundamental frequency of grating 80 is not in the optics domain.

For this value of spacing Λ₈₀ and so that the length L₈₀ of grating 80 is less than 10 cm, the number p of patterns is chosen to be less than 185. Here, p is chosen to be equal to 120, so that the length L₈₀ of grating 80 is approximately equal to 65 mm.

The patterns Mi are all structurally identical to one another and differ from one another only in their position along axis 108. In the following, therefore, only pattern Mᵢ is described in detail. This pattern Mᵢ extends mainly in a plane Pᵢ perpendicular to axis 108. This plane Pᵢ is therefore parallel to the X and Y directions. In FIG. 3, only the planes P₁, P₂, Pₚ₋₁ and Pₚ in which the patterns M₁, M₂, Mₚ₋₁ and Mₚ respectively extend are shown.

FIG. 4 shows a more detailed example of the pattern Mᵢ. In FIG. 4, only the cross-section of core 110 is shown.

Each pattern Mᵢ reflects part of the incident optical signal. Another part of the incident optical signal passes through the pattern Mᵢ. Finally, each pattern Mᵢ scatters part of the energy of the incident optical signal, which is then neither reflected nor transmitted through this pattern Mᵢ. This energy diffused by each pattern Mᵢ creates insertion losses caused by the presence of the grating 80 in the core 110 of the optical fiber 34. To minimize these insertion losses, the cross-sectional area S_{Mi} of pattern Mᵢ occupies less than half the cross-sectional area S₁₁₀ of core 110. The area S_{Mi} is equal to the area of the orthogonal projection of the pattern Mᵢ onto the plane Pᵢ. Surface area S₁₁₀ is equal to the cross-sectional area of core 110. Typically, the surface area S₁₁₀ is constant along the entire length of the optical fiber 34.

Preferably, the surface area S_{Mi} is less than 0.1*S₁₁₀ or 0.05*S₁₁₀ or 0.01*S₁₁₀. Here, the surface area S_{Mi} is less than 0.05*S₁₁₀.

To obtain sufficient reflectivity of the pattern Mᵢ to limit the number p of patterns and thus to limit the length L₈₀ of the grating 80, the surface area S_{Mi} is greater than 0.016 μm², i.e. greater than twice the area of the orthogonal projection of a spherical bubble of 100 nm in diameter onto the plane Pᵢ. In this embodiment, the surface area Smi is greater than or equal to 0.032 μm².

To this end, the pattern Mᵢ is made up of several bubbles Bⱼ. The index j is an identifier that uniquely identifies the bubble Bⱼ among all the other bubbles in the same pattern Mᵢ. The index j is an integer between 1 and q, where q is equal to the number of bubbles Bⱼ in the pattern Mᵢ. The number q is greater than or equal to two or four. Here, q equals six.

In this embodiment, all bubbles Bⱼ are structurally identical to one another. They can only be distinguished from one another by their position in the plane Pᵢ.

Each bubble Bⱼ creates a significant variation in the refractive index of the core 110 in the direction of propagation of the optical signal. To achieve this, the difference between the refractive index nᵣ₁₁₀ of the core 110 and the refractive index n_{rB} of the bubble Bⱼ is greater than 0.3 or 0.4. Here, the interior of each bubble is empty or virtually empty, corresponding to a difference between the indices nᵣ₁₁₀ and n_{rB} greater than or equal to 0.4.

In addition, to ensure that the refractive index change is abrupt, the diameter Dⱼ of each bubble Bⱼ is less than 200 nm and, preferably, less than 100 nm. Generally, the diameter Dⱼ is also greater than 10 nm or 50 nm.

Each bubble Bⱼ is predominantly spherical. Thus, the diameter Dⱼ of the bubble Bⱼ is equal to the diameter of the sphere of smallest volume containing the entire bubble Bⱼ. Here, this diameter Dⱼ is less than 100 nm.

The center of each bubble Bⱼ is contained in the plane Pᵢ.

In this embodiment, the bubbles Bⱼ are disjoint, i.e. they do not overlap and are not fluidly connected to one another.

The pattern Mᵢ is centered on axis 108. To achieve this, the bubbles Bⱼ are arranged side by side so that the barycenter of the pattern Mᵢ is located within 100 nm of axis 108 and the center of at least one of the bubbles Bⱼ is located within 100 nm of axis 108.

In this first embodiment, the barycenter of the pattern Mᵢ lies on axis 108. Furthermore, pattern Mᵢ is symmetrical with respect to axis 108.

The centers of bubbles Bⱼ are located one behind the other on an axis Aᵢ that intersects axis 108 and belongs to plane Pᵢ. The pattern Mᵢ thus comprises a line of disjointed bubbles. In this case, the arrangement of disjoined bubbles forms what is called a “dotted line” in this text. Here, the axis Aᵢ is parallel to the Y direction. In this embodiment, bubbles B₃ and B₄ are located above and below axis 108 respectively. The centers of bubbles B₃ and B₄ are less than 100 nm from axis 108.

The distance between two immediately consecutive bubbles Bⱼ, Bⱼ₊₁ along axis Aᵢ is constant. In other words, whatever the pair of bubbles Bⱼ, Bⱼ₊₁ immediately consecutive along axis Aᵢ, the distance separating the centers of these two bubbles is the same.

FIG. 5 shows the power spectrum of grating 80 between 1545 nm and 1555 nm. The reflectivity of the resulting comb peaks reaches −21 dBm.

FIG. 6 shows a method for manufacturing optical fiber 34. This method begins with step 120, in which an optical fiber is supplied, the core 110 of which is initially devoid of Bragg gratings. For example, the optical fiber supplied is the optical fiber marketed under the reference SMF-28 by the Corning® company.

Here, the mechanical sheath of this optical fiber is transparent to femtosecond laser pulses, so there's no need to remove this mechanical sheath at the locations where the patterns Mᵢ are to be made.

Then, in a step 122, the grating 80 is produced in the core 110. To do this, an operation 124 to form the pattern Mᵢ in the core 110 of the optical fiber supplied is repeated at each location where such a pattern Mᵢ is to be formed.

In operation 124, each bubble Bⱼ is created by a single femtosecond laser pulse. More precisely, during operation 124, the femtosecond laser beam is focused on the center of the bubble Bⱼ to be created, then a pulse with a duration of less than 500 fs or 250 fs is emitted and irradiates the point in core 110 where the center of the bubble Bⱼ is to be located. The bubble Bⱼ is then created in the core 110. The optical fiber is then moved relative to the femtosecond laser so that the femtosecond laser beam is now focused on the center of the next bubble Bⱼ₊₁ to be created, and a new femtosecond laser pulse is emitted.

In this embodiment, bubbles Bⱼ are created one after the other.

The values of the various parameters of a femtosecond laser to create a bubble such as the bubble Bⱼ depend on the characteristics of the optical fiber supplied and the characteristics of the femtosecond laser used. The adjustment of these different parameters to create the bubbles Bⱼ previously characterized is a matter for the skilled person. For example, by way of illustration, the reader may refer to application CN211603608U, which describes in detail an example of an installation for forming bubbles such as bubbles Bⱼ in the core of an optical fiber. Here, the following parameters were used to manufacture optical fiber 34:
the central wavelength of the femtosecond laser pulse is 512 nm,
the duration of each femtosecond laser pulse is 160 fs, and
the power of each femtosecond laser pulse is equal to 45 nJ.

The operation of measuring device 2 will now be described with reference to the method shown in FIG. 7.

In a step 130, unit 70 controls source 50 to vary wavelength λₛ linearly over time from wavelength λₛₘᵢₙ to wavelength λₛₘₐₓ. To this end, unit 70 sends source 50 a control signal generated from an estimate of source 50's transfer function.

The optical signal emitted by source 50 is guided by coupler 52 and optical fibers 22, 14, 42 and 34 to transducer 4 and standard 6. Transducer 4 and standard 6 then reflect part of the incident optical signal. These reflected parts of the optical signal correspond to the signals backscattered by transducer 4 and standard 6 respectively.

In parallel with step 130, in step 132, sensor 62 measures only the optical signal backscattered by transducer 4, and sensor 64 measures only the optical signal backscattered by standard 6. More precisely, sensors 62, 64 each generate an electrical signal whose amplitude is representative of the power of the measured optical signal. The electrical signals generated by sensors 62, 64 are transmitted to and acquired by unit 70.

Once the electrical signals have been acquired by unit 70, in a step 134, unit 70 determines the amplitude Δλ.

When the wavelength λₛ is equal to the wavelength λ_{Bm4} of transducer 4, the power of the optical signal backscattered by transducer 4 passes through a maximum. Since the wavelength λₛ varies linearly with time, the instant tₘ at which this maximum occurs is proportional to the current value of the wavelength λ_{Bm4}. Similarly, the reference wavelength λ_{Bi4} corresponds to a reference instant tᵢ. In step 134, unit 70 calculates the deviation between the measured time tₘ and the reference time tᵢ. Since the wavelength variation λₛ over time is linear, the deviation tₘ-tᵢ is proportional to the amplitude Δλ. The coefficient of proportionality between the deviation tₘ-tᵢ and the amplitude Δλ is equal to the target slope α_{c} of the line representing the evolution over time of the wavelength λₛ. This target slope α_{c} is a predetermined and known constant. Thus, in step 134, unit 70 determines Δλ from the deviation measured between instants tₘ and tᵢ.

Then, in a step 136, unit 70 establishes the variation ΔG of the measured physical quantity from the amplitude Δλ. For example, the variation ΔG is calculated using the following relationship Δλ/λ_{Bi4}=S_{G}*ΔG, where S_{G} is the sensitivity coefficient pre-stored in memory 74. If the wavelength λ_{Bi4} is associated, in memory 74, with a corresponding absolute value of the physical quantity to be measured, then unit 70 also calculates this absolute value of the physical quantity measured in step 136.

Here, in a step 140, each time the power spectrum of standard 6 is measured by sensor 64, unit 70 establishes a new estimate of the transfer function of source 50. To do this, for example, unit 70 records the time t_{k,m} at which each k-order peak occurs in the comb of standard 6. Unit 70 then associates the recorded time t_{k,m} with the wavelength λₖ of this k-order peak. The combination of time t_{k,m} and wavelength λₖ forms a point (λₖ; t_{k,m}) with abscissa λₖ and ordinate t_{k,m}. The estimated transfer function for source 50 then corresponds to the curve that passes through the set of points (Δₖ; t_{k,m}) found for standard 6.

This estimated transfer function is then used in the next execution of step 130 to generate the control signal for the source 50 that achieves a linear variation, over time, of the wavelength λₛ with the target slope α_{c}. For example, to achieve this, each instant t_{k,m} is compared with a theoretical instant t_{k,t} at which the peak of order k should have occurred if the variation in wavelength λₛ were perfectly linear and with slope α_{c}. The theoretical time t_{k,t} is therefore calculated from the wavelength λₖ of the kth-order peak and the predetermined, known target slope α_{c}. If the amplitude of the deviation t_{k,m}-t_{k,t} exceeds a predetermined threshold, then the control signal is locally modified between instants t_{k-1,t} and t_{k,t} to limit the amplitude of this deviation. For example, if the deviation t_{k,m}-t_{k,t} is positive, this means that time t_{k,m} lags behind time t_{k,t}. In this case, the control signal is modified between instants t_{k-1,t} and t_{k,t} to make the wavelength λₛ grow faster between these instants t_{k-1,t} and t_{k,t}. Conversely, if the deviation t_{k,m}-t_{k,t} is negative, this means that time t_{k,m} is ahead of time t_{k,t}. In this case, the control signal is modified between instants t_{k-1,t} and t_{k,t} to make the wavelength λₛ increase more slowly between these instants t_{k-1,t} and t_{k,t}.

Thus, in this embodiment, the measured spectrum of standard 6 is used to linearize the variation, over time, of wavelength λₛ. This linearization improves the accuracy of the measurement and also compensates for drifts in the source 50. In this way, therefore, the measurement of the spectrum of the standard 6 is involved in determining the amplitude Δλ.

FIG. 8 shows an standard 150 that can be used in place of standard 6. Standard 150 is identical to standard 6, except that a second Bragg grating 152 is formed in optical fiber 34. To simplify FIG. 8, only the core 110 and the gratings 80 and 152 are shown.

Grating 152 is a standard Bragg grating whose fundamental frequency wavelength λ_{B152} lies within the working range. The absolute value of the wavelength λ_{B152} is known. Here, the patterns of grating 152 are shaped so that the amplitude of the power peak of grating 152 at wavelength λ_{B152} is greater than, and preferably 1.5 times or twice, the amplitude of the comb peaks of grating 80 in the working range.

For example, grating 152 is formed in core 110 at the same location as grating 80, but is offset radially from grating 80 so that its patterns do not interfere with the patterns of grating 80. For example, grating 152 is formed in the upper part of core 110, while grating 80 is formed in the lower part of core 110. The upper part of the core 110 is that located above a horizontal plane containing axis 108 and the lower part is that located below this horizontal plane.

The power spectrum of standard 150 is equal to the superposition of the spectrum of grating 80 and the spectrum of grating 152. Thus, in addition to the comb of peaks, the spectrum of standard 150 includes an extra peak at wavelength λ_{B152}. This additional peak is easily identifiable because its amplitude is greater than the amplitude of the peaks of the comb of grating 80.

When standard 6 is replaced by standard 150, unit 70 is modified to additionally determine the absolute values of the wavelengths corresponding to each of the comb peaks of grating 80. To do this, unit 70 locates the largest power peak, i.e. that corresponding to grating 152, in the measured spectrum of standard 150. The absolute value of the wavelength at which this largest peak appears in the power spectrum of the standard 150 is known and is equal to the wavelength λ_{B152}. The positions of the peaks of the comb of grating 80 relative to the largest peak are determined from the measured spectrum of the standard 150. Then, for each peak of the grating comb 80, the unit 70 determines the absolute value of the wavelength corresponding to this peak from:
the number of free spectral ranges separating it from the largest peak, and
the absolute value of the wavelength λ_{B152}.

For example, if a comb peak of grating 80 is separated from the largest peak by 5.5 free spectral ranges, then the absolute value of the wavelength at which this peak appears is equal to λ_{B152}+5.5*ISL₈₀, where ISL80 is the known value of the free spectral range of grating 80.

From the absolute values of the wavelengths of the comb peaks, unit 70 is then able to estimate a transfer function for source 50 that associates an absolute value of wavelength λₛ with a particular value of the control signal. This simplifies the generation of a control signal that linearly varies the wavelength λₛ as a function of time. It is also possible, in this case, to establish the absolute value of the wavelength λ_{Bm4} directly. Unit 70 then establishes the absolute value of the physical quantity to be measured from a known relationship between the absolute value of the wavelength λ_{Bm4} and the absolute value of the physical quantity.

### Chapter II: Variants

Standard variants

The order kc of the harmonic at the center of the working range is greater than 100 and, preferably, chosen greater than 500 or 1000. This order k_{c} can also be chosen to be greater than 2000 or 4000 or 10000. Theoretically, there is no upper limit for this order k_{c}. However, it follows from relation (2) that the higher the order k_{c}, the greater the spacing Λ of the Bragg grating, and therefore the longer the Bragg grating of very high order. In practice, therefore, it is the desired maximum length of the Bragg grating that imposes an upper limit on the order k_{c}. Here, this maximum length is set at 1 m.

Similarly, the minimum value of the spacing Λ is greater than 20 λm and, typically, greater than 50 μm so that very high-order harmonics are included in the optics domain. Theoretically, there is no maximum value for the spacing Λ. In fact, whatever the value chosen for the spacing Λ, it is possible to find a value for the order k_{c} that places the wavelength λ_{c} at the center of the working range. However, the larger the spacing Λ, the longer the Bragg grating. In practice, therefore, it is also the maximum desired length for the Bragg grating that imposes an upper limit for the value of the spacing Λ.

By way of example, by applying the teaching given in Chapter I, it is possible to obtain combs for all working ranges. This applies in particular to working ranges centered on wavelengths commonly used in optics, such as 800 nm, 1000 nm, 1300 nm or 1500 nm.

The working range can be wider than 100 nm. For example, the width of this working range is, alternatively, greater than 200 nm or 300 nm. There is no upper limit to the width of this working range, except that it must lie in the optics domain and must be capable of being scanned by the laser source of the spectral analyzer.

The various variants of the ultra-high-order Bragg grating pattern described in the application filed on 29/07/2022 under No. FR2207936 by the present applicant apply to the ultra-high-order Bragg gratings of the measuring device described here.

The ultra-high-order Bragg grating patterns produced in the optical fiber core can have different shapes. For example, in one embodiment, each pattern comprises a single bubble. In another embodiment, as described in article LUO2022, each pattern has the shape of an ellipse.

Optical fibers other than SMF-28 can be used. For example, the optical fiber can be a multimode optical fiber or MMF (Multi-Mode Fiber).

The core of the optical fiber does not have to be specifically doped. For example, the described manufacturing method can be used with optical fibers whose core is made of germanosilicates, pure silica, rare-earth-doped aluminosilicates or sapphire.

In a particular embodiment, the characteristics of the optical fiber 34 in which the standard 6 is produced are different from the characteristics of the optical fiber 14, so that the sensitivity of the standard to variations in the physical quantity to be measured is less than the sensitivity of the optical transducer 4 to these same variations in the physical quantity.

### Insulating Structure Variants

Other types of insulating structure are also possible. For example, grating 80 can be isolated from variations in mechanical stress by implementing the teaching of application FR3087008A1.

The insulating structure can also be designed to isolate grating 80 from variations in hydrostatic pressure.

In a simplified embodiment, the insulating structure is not an active insulating structure but a passive insulating structure, i.e. an insulating structure that does not consume electrical energy to isolate the optical fiber 34 from variations in the external environment. For example, a passive insulating structure comprises a material with a very low coefficient of thermal expansion, to which the optical fiber is fixed without any degree of freedom. Typically, this material with a very low coefficient of thermal expansion has a coefficient of thermal expansion of less than 5*10⁻⁶ K⁻¹. For example, this material is an iron-nickel alloy such as Fe—Ni alloy with 36% atomic nickel. This alloy is known as Invar®. In another example of a passive insulating structure, the optical fiber is embedded inside a material with a thermal conductivity of less than 0.05 W/m/K.

In another embodiment, the insulating structure comprises a material that exerts a mechanical stress on the optical fiber to compensate for the effect of thermal expansion of the optical fiber in response to a temperature variation.

The housing 82 can be omitted in particular if the mechanical stress exerted by the external environment on the grating 80 cannot vary or varies only negligibly.

### Optical Transducer Variants

The optical transducer does not necessarily include a Bragg grating. Alternatively, the optical transducer may comprise a Fabry-Perot interferometer instead of a Bragg grating. Like a Bragg grating, such a Fabry-Perot interferometer has a power spectrum with a peak whose position varies as a function of temperature, elongation stress and the hydrostatic pressure exerted on the Fabry-Perot cavity. Such a Fabry-Perot interferometer can be implemented in the core of an optical fiber. In another variant, the optical transducer is a gas cell whose transmission power spectrum comprises an absorption line. The position of this absorption line in the power spectrum varies, for example, as a function of temperature.

When the optical transducer is a Bragg grating, the power spectrum of the optical transducer is shifted in response to a variation in temperature, a longitudinal deformation of the optical fiber core or a variation in hydrostatic pressure. In this way, all of the preceding embodiments can be adapted to measure a physical quantity selected from the group consisting of temperature, longitudinal deformation of the optical fiber core and a variation in hydrostatic pressure. Using the measurement of one of these physical quantities, it is possible to derive measurements for other physical quantities such as vibration, acceleration or acoustic wave detection.

The physical quantity measured can also be a physical quantity other than temperature, longitudinal deformation or hydrostatic pressure. All that's needed is for the optical transducer to be sensitive to this other physical quantity. For example, the optical transducer can be sensitive to a dose of radiation. By way of illustration, the core of optical fiber 14 is made of a photosensitive material. Here, the core is made of germanosilicate. Initially, a Bragg grating is produced in the core of optical fiber 14. This Bragg grating is then transformed into a Bragg grating sensitive to a dose of the radiation to be measured. To do this, this fabricated Bragg grating is exposed to ultraviolet radiation to create colored centers resulting from the recombination of bonds between germanium and silica. When subjected to a dose of the radiation to be measured, these colored centers are modified, leading to a shift in the wavelength λ_{Bm4} of the optical transducer's Bragg grating.

Alternatively, the optical transducer comprises a succession of Bragg gratings produced one after the other in the core of the same optical fiber. In this case, preferably, the wavelengths λ_{Bi4} of each of these Bragg gratings are different. Thanks to this, the same optical transducer can measure the physical quantity at different locations. In this embodiment, the power spectrum of the optical transducer then comprises several power peaks in the working range.

In another variant, the measuring device comprises several optical transducers optically connected in parallel to the spectral analyzer. Such a configuration of several optical transducers is illustrated, for example, in application CN102879022A.

Alternatively, the optical transducer is not built into the optical fiber 14, but is simply optically connected to the distal end of the optical fiber 14. For example, the optical transducer is a Fabry-Pérot cavity formed between two reflecting mirrors, and these mirrors are made outside the optical fiber 14.

### Spectral Analyzer Variants

Alternatively, the optical source is not tunable. For example, the optical source is a broad laser source, i.e. a laser source that emits an optical signal whose power spectrum simultaneously covers the entire working range. In this case, the optical signal emitted is not single-frequency. Furthermore, for each spectral response to be measured, the spectral analyzer then comprises a plurality of photodetectors that simultaneously measure the power of the spectral response for a large number of different wavelengths. For example, in this case, each sensor 62, 64 is an array spectrometer. In such an embodiment, it is not necessary to vary the wavelength As to scan the entire working range. Estimation of the laser source transfer function can then be omitted.

The optical source is not necessarily a laser source. For example, the optical source can also be a tunable Fabry Perot cavity. In this case, the control signal causes the displacement of at least one of the optical interfaces of this Fabry Pérot cavity. This displacement of an optical interface then causes a change in the cavity's natural resonance frequency and hence a change in wavelength λₛ.

Other configurations of unit 70 are possible for determining the amplitude Δλ. In particular, the amplitude Δλ can also be determined without using the time difference tₘ-tᵢ. For example, alternatively, the amplitude Δλ is determined by counting the number of peaks in the spectrum of the standard lying between the wavelength λ_{Bi4} and the measured wavelength λ_{Bm4}. Such a method is described, for example, in the “Absolute Frequency Measurement” section of the application WO2020113147A1.

In another variant, the estimated transfer function for source 50 is used to correct the wavelength λ_{Bm4} so as to obtain a corrected wavelength closer to reality. For example, to do this, the corrected wavelength λ_{Bm4} is calculated using the following relationship: λ_{Bm4}=[(λₖ₊₁−λₖ)/(t_{k+1,m}−t_{k,m})]*(tₘ−t_{k,m})+λₖ, where:
λₖ and t_{k,m} are, respectively, the abscissa and ordinate of the point (λₖ; t_{k,m}) of the transfer function estimated in step 140 for which t_{k,m} immediately precedes the instant tₘ measured in step 134, and
λₖ₊₁ and t_{k+1,m} are, respectively, the abscissa and ordinate of the point (λₖ₊₁; t_{k+1,m}) of the transfer function estimated in step 140 for which t_{k+1,m} immediately follows the instant tₘ.

In this variant, a linear interpolation of the transfer function is performed between two successive points (λₖ; t_{k,m}) and (λₖ₊₁; t_{k+1,m}). However, non-linear interpolation of the transfer function between these two points is also possible.

In the above cases, standard 6 is not used to linearize the variation in wavelength λₛ of the optical source.

In a simplified variant, unit 70 determines only the variation of the measured physical quantity and not its absolute value. In this case, it is not necessary to know the value of the measured physical quantity corresponding to the wavelength λ_{Bi4}.

In another embodiment, the spectral response of the standard 6 is first measured and only then is the spectral response of the optical transducer 4 measured. In this case, an optical switch is first placed in a calibration position in which it optically connects the spectral analyzer 20 only to the standard 6 to measure the spectral response of the standard. Then, this optical switch is switched to a measurement position in which it optically connects the spectral analyzer 20 only to the optical transducer 4 to measure the spectral response of the optical transducer. Typically, the spectral response of the standard 6 is then only measured intermittently and not each time the spectral response of the optical transducer 4 is measured. In this embodiment, the optical signal illuminating the standard 6 is not necessarily strictly identical to the optical signal illuminating the optical transducer 4, since they are emitted at two different times Alternatively, at least one and preferably both optical sensors are connected to the distal end of optical fibers 14 and 34. In this case, the spectral analyzer 20 measures the optical signals that have passed through the transducer 4 and the standard 6. As a result, the power spectra of the measured signals are transmission power spectra, not reflection power spectra. However, everything that has been described for the particular case of reflection power spectra can be adapted, without any particular difficulty, to the case of transmission power spectra.

Optical couplers 12, 32 and 52 can be replaced by a single multi-channel optical coupler, which performs the functions of all three optical couplers 12, 32 and 52.

### Manufacturing Method Variants

There are many variants of the manufacturing method for a very high-order Bragg grating. In particular, all the manufacturing methods and their variants described in the application filed on 29/07/2022 under No. FR 2207936 by the present applicant can be used to manufacture grating 80. The manufacturing method described in article LUO2022 can also be used.

### Other Variants

The waveguide is not necessarily an optical fiber. Everything described in this text in the particular case of optical fibers also applies to the case where the waveguides are waveguides realized on a photonic chip. For example, in the latter case, the core of each waveguide is made of monocrystalline silicon or another semiconductor material, and the cladding is made of a material commonly used in silicon optics, such as silicon oxide.

Everything described above for the particular case where the wavelength Ac of the peak of order kc is between 200 nm and 5000 nm also applies to the case where the wavelength Ac is between 5000 nm and 10000 nm and, in particular, to the case where the wavelength Ac is in the infrared range. When the wavelength Ac is in the infrared range, the core of the optical fiber is made of chalcogenide glass, for example.

Several of the variants described above can be combined in a single embodiment.

### Chapter III: Advantages of the Described Embodiments

A very high-order Bragg grating makes it possible to obtain a comb of peaks using a single Bragg grating and not a succession of several Bragg gratings as described in application CN102879022A. So, compared with the standard described in application CN102879022A, the standard described in the preceding chapters is simpler to make and less cumbersome.

In addition, a very high-order Bragg grating produces a comb of peaks identical to those obtained using a Fabry-Perot cavity such as that described in application WO2020113147A1. On the other hand, for the same performance, the very high-order Bragg grating is simpler to manufacture and takes up less space.

The small footprint of the high-order Bragg grating not only reduces the size of the measuring device, but also makes it easier to build the insulating structure. Indeed, it is much easier to thermally insulate a high-order Bragg grating less than 10 cm long than a Fabry-Perot cavity several meters long.

Accordingly, a measuring device with a standard fabricated using a very high-order Bragg grating is simpler to manufacture for the same performance.

Using the spectral response of the standard 6 to obtain a linear variation in the wavelength emitted by the laser source 50 over the entire working range, simplifies the structure of the sensors 62, 64 and therefore the structure of the measuring device.

Simultaneously measuring the spectral responses of the optical transducer 4 and the standard 6 when they interact with the same optical signal ensures that the spectral responses measured are indeed spectral responses obtained in response to the same optical signal. This increases the accuracy of the measuring device.

The fact that the standard 150 also includes a Bragg grating 152 whose wavelength λ_{B152} lies within the working range, makes it possible to identify the absolute value of the wavelength associated with each peak of the comb of grating 80. It is therefore possible to measure the absolute value of the wavelength at which the power peak of the optical transducer 4 occurs, and thus to trace back to an absolute value of the physical quantity measured.

The fact that the standard is made of optical fiber simplifies the manufacture of the measuring device.

The use of one or more bubbles in each pattern Mi results in a small pattern and therefore substantially reduces insertion losses.

The use of several disjointed bubbles results in a pattern Mi that is sufficiently reflective to reduce the number p of patterns and thus maintain the compactness of grating 80, while limiting insertion losses. Indeed, when bubbles overlap, the overlapping zones between several bubbles are subjected to several successive femtosecond laser pulses. It has been observed that an area of the optical fiber core subjected to several femtosecond laser pulses degrades. This degradation increases diffusion losses. Conversely, when the bubbles are disjointed, such overlapping zones do not exist, limiting insertion losses.

1. A device for measuring a physical quantity, this device comprising:
an optical transducer whose power spectrum has at least one power peak whose position varies, while remaining within a predetermined working range, as a function of the physical quantity to be measured, this predetermined working range being a wavelength range and this working range being between 200 nm and 10000 nm,
a standard whose power spectrum in reflection comprises several power peaks distributed within the working range, the free spectral range of this standard being less than or equal to 5 nm, this standard comprising:
a first waveguide containing a core which extends along a longitudinal axis and within which an optical signal guided by this first waveguide is configured to propagate along the longitudinal axis of the first waveguide, and
a first Bragg grating produced in the core of the first waveguide, this first Bragg grating comprising at least three identical patterns aligned one behind the other along the longitudinal axis of the first waveguide and separated from one another by a first constant spacing,
an insulating structure configured to isolate the first Bragg grating from variations in temperature and mechanical stress exerted on the standard by an external environment,
a spectral analyzer configured to:
separately measure the spectral response of the optical transducer in the working range and the spectral response of the standard in the same working range, then
determine the amplitude of the shift of the optical transducer peak from the spectral responses of the optical transducer and the standard measured separately from each other, then
establish a variation in the physical quantity from the determined amplitude of the optical transducer peak shift,
wherein the first spacing of the first Bragg grating is configured so that the power spectrum of the first Bragg grating has several discernible harmonics of order greater than one hundred in the working range, these harmonics thus forming the power peaks of the power spectrum of the standard at known wavelengths.

2. The device according to claim 1, wherein:
the spectral analyzer comprises a tunable optical source configured to emit a single-frequency optical signal which interacts with the optical transducer and the standard, this optical source being tunable by means of a control signal to vary the wavelength of the emitted optical signal, the wavelength of the emitted optical signal being related to the control signal by a non-linear transfer function, and
the spectral analyzer is also configured to:
estimate the non-linear transfer function of the tunable optical source from the measured spectral response of the standard and the known wavelengths at which the power peaks of the standard's power spectrum occur over the working range, then
build a control signal that provides a more linear variation, as a function of time, of the wavelength of the optical signal emitted over the entire working range from the estimated transfer function, and
control the optical source using this built control signal.

3. The device according to claim 1, wherein:
the spectral analyzer comprises:
a laser source equipped with an output port through which an optical signal is emitted, and
an optical coupler which optically connects the optical transducer and the standard simultaneously to this output port, and
the spectral analyzer is configured to simultaneously measure the spectral responses of the optical transducer and the standard obtained in response to the optical signal emitted on the output port.

4. The device according to claim 1, wherein the standard waveguide is an optical fiber.

5. The device according to claim 1, wherein:
each pattern of the first Bragg grating extends mainly in a plane, called the “pattern plane”, perpendicular to the longitudinal axis of the first waveguide, and
each pattern consists of one or more bubbles arranged side by side in the plane of the pattern, and
the area of the orthogonal projection of all the bubbles of the pattern onto the pattern plane is less than 50% of the cross-sectional area of the core of the first waveguide.

6. The device as claimed in claim 5, wherein each pattern consists of a plurality of disjoint bubbles arranged side by side in the plane of the pattern.

7. The device according to claim 1, wherein:
the first spacing is greater than or equal to 20 μm, and
the difference between the refractive index of the core of the first waveguide and the refractive index of each pattern of the first Bragg grating is greater than 0.3.

8. The device according to claim 1, wherein each pattern is produced using a femtosecond laser pulse.

9. The device according to claim 1, wherein the physical quantity is selected from the group consisting of temperature, mechanical deformation and hydrostatic pressure.

10. The device according to claim 1, wherein the working range is between 200 nm and 5000 nm.

11. A standard for the realization of a measuring device according to claim 1, wherein the reflection power spectrum of said standard comprises several power peaks distributed within a predetermined working range, the free spectral range of said standard being less than or equal to 5 nm and said predetermined working range being a wavelength range and said working range being comprised between 200 nm and 10000 nm, said standard comprising:
a first waveguide containing a core which extends along a longitudinal axis and within which an optical signal guided by the waveguide is configured to propagate along the longitudinal axis of the waveguide, this waveguide being adapted to be optically connected to a spectral analyzer,
a first Bragg grating produced in the core of the first waveguide, this first Bragg grating comprising at least three identical patterns aligned one behind the other along the longitudinal axis of the first waveguide and separated from one another by a first constant spacing,
an insulating structure configured to isolate the first Bragg grating from variations in temperature and from variations in mechanical stress exerted on the standard by an external environment, this insulating structure comprising:
a temperature sensor,
a tunable heating or cooling element for heating or cooling the first waveguide, and
a microcontroller configured to control the heating element as a function of a temperature setpoint and the temperature measured by the sensor, in order to limit the temperature variation of the first waveguide around this temperature setpoint,
wherein the first spacing of the first Bragg grating is configured so that the power spectrum of the first Bragg grating has several discernible harmonics of order greater than one hundred in the working range, these harmonics thus forming the power peaks of the power spectrum of the standard at known wavelengths.

12. The standard according to claim 11, wherein the standard comprises a second Bragg grating made in the core of the first waveguide, this second Bragg grating comprising at least three identical patterns aligned one behind the other along the longitudinal axis of the first waveguide and separated from one another by a second constant spacing, this second spacing being configured so that the wavelength of the fundamental resonant frequency of the second Bragg grating lies within the working range.
